(19) United States
(12) Patent Application Publication
(10) Pub. No.: US 2004/0193611 A1
(43) Pub. Date: Sep. 30, 2004

(54) A system for using telephone numbers for emails and for a more efficient search engine.

(75) Inventor: Padmanabhan Raghunandhan, Chennai (IN)

Correspondence Address: PADMANABHAN RAGHUNANDHAN, NO. 7, 25TH CROSS STREET, BESANT NAGAR, CHENNAI, TAMIL NADU, 600090, IN

(73) Assignee: Padmanabhan Raghunandhan, Somerset, NJ (US)

(21) Appl. No.: 10/708,494

(22) Filed: Mar. 8, 2004

(30) Foreign Application Priority Data
Mar. 31, 2003 (IN) 265/MAS/2003

(51) Int. Cl. G06F 7/00

(52) U.S. Cl. 707/10

(57) ABSTRACT

The present invention is directed toward a system that uses telephone numbers or numbers such for sending receiving emails. The invention also proposes a search engine catered towards locating businesses or acquiring information, using zip codes, telephone area codes, landmarks or other well known mnemonics. The inventions also propose using telephone numbers for conducting secure e-commerce on the Web. This will make navigation and usage of the Internet using wireless communication devices easier, efficient and user-friendlier.

### BACKGROUND OF INVENTION

Field of the Invention The present invention relates to sending/receiving emails using telephone numbers and/or similar “well known” entities (such as social security numbers, PAN's etc) and for building a search engine, using the telephone area codes, postal zip codes and other regional/local mnemonics. This search engine is more efficient and faster than current technologies for locating entities pertaining to a geographic region. The invention also pertains to conducting commercial transactions on the Web using telephone numbers in a secure manner. The invention will also help in a better use/functioning of wireless related web services. The telephone numbers (in structure in US is <area code> <3 digit prefix> <4 digit number>, specifically the area code and the prefix can be used to search the web for businesses and other entities pertaining to a geographic location. The area code will determine the State (for e.g. in the United States area code “703” is for Virginia and prefix “860” is for Reston). The search can also be conducted using zip code, landmarks, airport code and other entities described below. These entities will be used to derive the desired geographic location and its latitude/longitude. The latitude/longitude (and/or Zip Code) will then be used to provide search results with that latitude/longitude/zip code as the focal point.

The country code can be derived from the Zip Code to some extent. For e.g. Zip codes in US are 5 digits long and in India are 6 digits long. Zip codes in Europe contain alphabets. It is also possible to derive the country code from a combination of Zip code structure and IP address of the user.

### SUMMARY OF INVENTION

The present invention is directed to a method and apparatus for sending and receiving emails, searching the World Wide Web for regional businesses and other entities, using telephone numbers, zip codes, landmarks and other well known entities. The users will also be provided the ability to use a combination of their names and phone number to send emails instead of just phone numbers. This would enable different members of a household or business to set up multiple mailboxes within the same telephone number.

In yet another embodiment of the present invention, a search engine for locating regional businesses can be provided using telephone area codes, postal zip codes and/or well-known regional names. This search engine will be faster, more efficient and scalable compared to current search engines.

In yet another embodiment of the present invention, telephone numbers can be used for conducting secure commercial transactions on the web. Users will be able to buy good and services on the Web using their telephone numbers in a more secure manner than currently available.

### BRIEF DESCRIPTION OF DRAWINGS

These and other objects and advantages of the present invention will become more apparent and more readily appreciated from the following description of the preferred embodiments, taken in conjunction with the accompanying drawings, of which:

FIG. 1 is a diagram of a user requesting doctor's information in Culpeper Va., using his/her phone number as the focal point.

FIG. 2 is a block diagram of a user computer sending/receiving email according to one embodiment of the present invention. Note that the structure of the message changes, not the way in which emails are generated.

FIG. 3 shows a user requesting Lexus car dealerships closest to the Dulles airport..The descriptions of the drawings, is intended to provide a detailed description of an example of the invention and should not be construed to be limiting of the invention itself. Any number of variations may fall within the scope of the invention that is defined in the claims.

The Zip codes and addresses shown may not reflect the actual zip codes/addresses used in the regions. They are for illustration purposes only.

The web browser used for illustrating the examples is the Microsoft Internet Explorer.™. However, other web browsers, such as Netscape can also be used to implement the present invention.

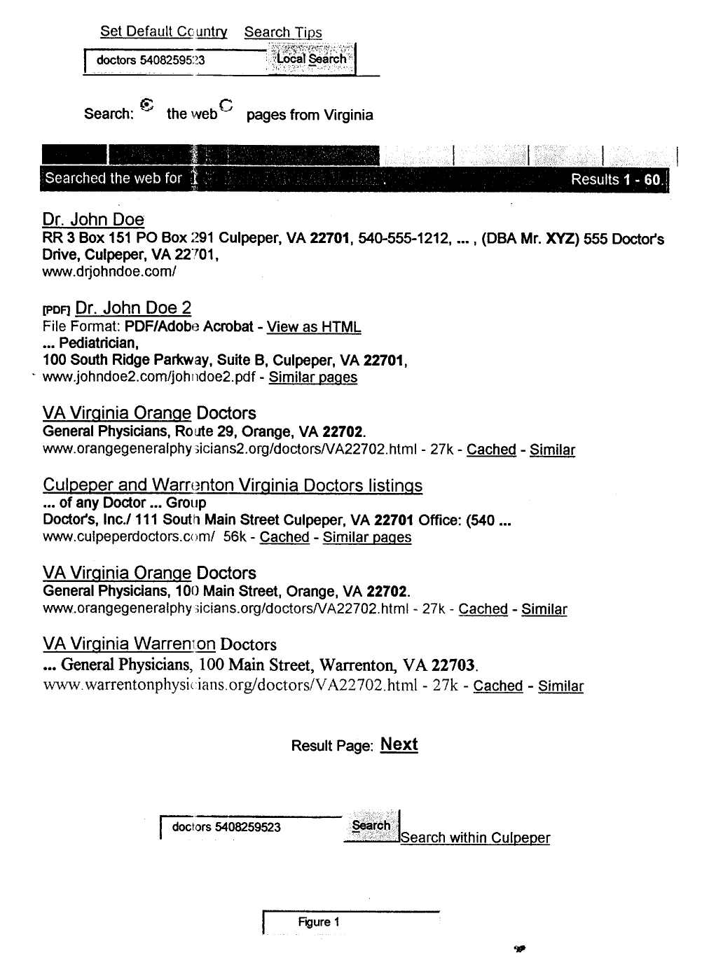

FIG. 1 is a diagram of a user requesting doctor's information in Culpeper Va., using his/her phone number as the focal point. From the phone number in the input string, it can deduced that the state of interest is Virginia (540 area code) and from the prefix 825 it can further be narrowed down to Culpeper, Va. (within the area code 540). The result would provide doctors office in other zip codes ahead of the one's within the requested zip code, if they are closer to the point of interest. In the example the doctors office in “Orange Route 29” Virginia is given ahead of the one in Culpeper because it is closer to the center of the Zip code.

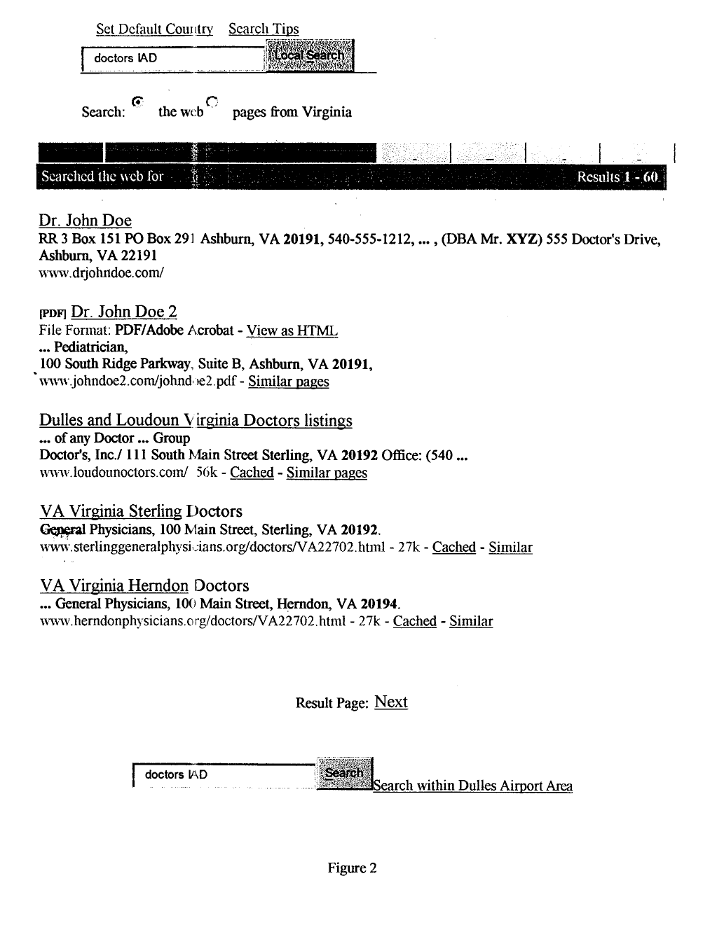

FIG. 2 is a block diagram of a user computer sending/receiving email according to one embodiment of the present invention. Note that the structure of the message changes, not the way in which emails are generated.

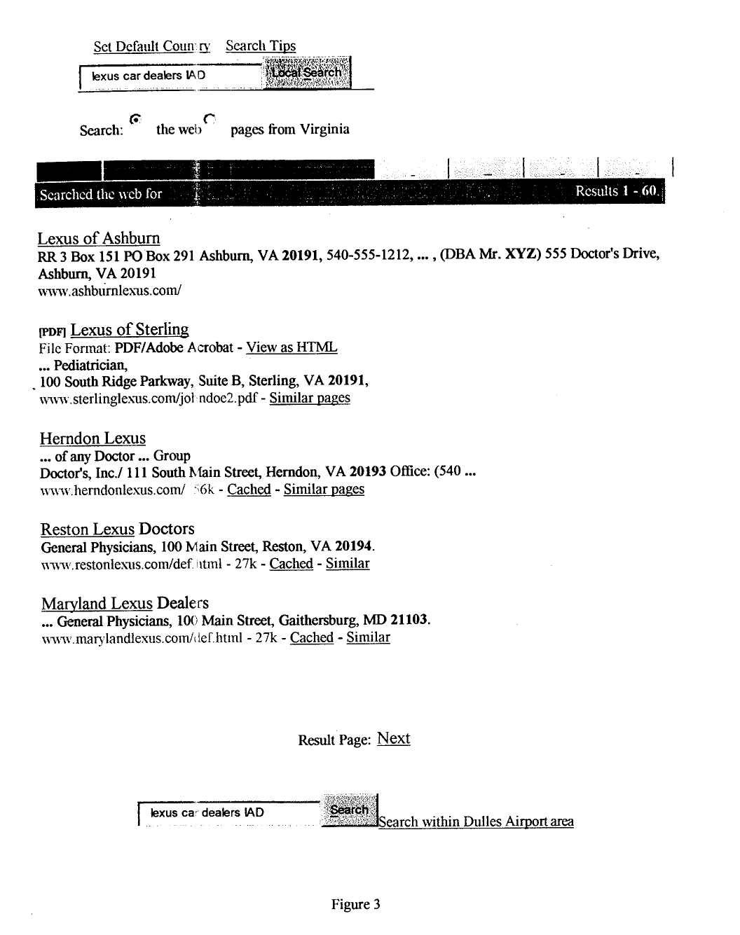

FIG. 3 shows a user requesting a search for all Lexus dealerships that are close to the Dulles airport (IAD Virginia). The results start from the one that is closest to the Dulles airport. Every entity displayed is closer (or the same distance) to the Dulles airport than the next entity.

### DETAILED DESCRIPTION

Most users of the Internet use email addresses that are linked to their service providers such as AOL, Satyam, VSNL etc. The email addresses are of the form John-Doe@aol.com, JohnDoe@vsnl.com etc. Over a period of time these email addresses become very valuable to the individuals. The users cannot switch to other service providers for fear of losing their identity (email address). This is causing a lot of inconvenience and monetary loss for the consumers.

The patent describes a method wherein users can use their telephone numbers for sending/receiving email, which is relatively permanent and not related to any service provider. It is “relatively permanent” because users will be expected to “give up” their email addresses once their telephone number changes and the old number has been assigned to a new individual/business. However, automatic forwarding and notification of the change will be generated to the senders of e-mail's generated to the old address.

The explosive growth of the Internet in recent years and the scrambling by individuals and businesses to obtain relevant and descriptive domain names is a well-known problem. It has been estimated that new Internet domain names are being added at a rate of one every 2.6 seconds. Even though there are a finite few, accepted top domains available, such as “.com”, “.org”, “.net” etc. the rush to develop and reserve meaningful domain names is accelerating rapidly. Individuals and businesses want to register user-friendly web site names, often before they are sure how they will use their web sites, in order to pre-empt others from allocating these names. While one study reports that more than 80% of the registered domain names have a “com” top domain, the usage of other top domains is increasing. The unique portion of the domain name (the second level domain name) is that portion of the domain name that distinguishes one domain name from another. As shorter domain names are used up (second level domains), domain names are becoming longer and longer in order to remain unique. The use of telephone numbers as domain names will reduce/eliminate most of the problems, especially for individuals.

Email Using Telephone Number: It is possible to use one's telephone number as a domain name and be able to send and receive email messages with it. Default email addresses such as mail@15551212.tel can be created (where the telephone number is 15551212 and “.tel” is a hypothetical Top level Domain indicating that the structure of domain names within this TLD is a phone number. However, it is not restricted to this TLD and can be used using other TLD's such as “.com” etc).

User can customize the mailboxes by creating email id's such as JohnDoe@15551212.tel. This will restrict the number of “junk” emails received by the user and will also provide privacy within their household or business.

Users will be able to conduct e-commerce using just their telephone number. They will have the ability to provide a password to the merchants for each transaction (or set password based on amounts i.e. below $50, between $50 and $100 another password and so on). There will be two levels of encryption—one with the password for the transaction and the other with the private key of the user (using RSA algorithm). The merchant first decrypts using the public key of the user and then with the password provided for the transaction. The merchant extracts the credit card information, after the successful decryption at both stages.

For mobile users the telephone number can be used to customize what is displayed on the mobile device and navigation through the browser can be simplified.

A GPS device (Global Positioning System) converts the position to either latitude/longitude (2-dimensional) or latitude/longitude/altitude (3 dimensional). This information can be integrated with a mobile device for providing regional advertisements. For e.g. a mall can provide targeted advertisements to customers within a 10-mile radius. A mobile user will also be able to search for restaurants/gas stations nearest to his/her current location.

Search Engine: The search engines currently in existence are useful for accessing information from the Web. However, they are not efficient in providing regional/local information. The proposed search engine helps in locating businesses and other items/entities of interest in the proximity of one's place of residence. For example, a user wanting to search for Pizzeria's close to his/her place of residence will not be able to do so with ease. The online yellow pages provides all the pizzeria's in a given region but does not provide information starting from the pizzeria closest to his/her place of residence/interest.

The present inventive system provides the user with search results that is relevant to his/her place of residence or interest. The results provided in the search will order the pizzeria's starting with the one closest to his/her home or point of interest. All Pizzeria's within a certain distance (configured based on country) will be provided, but the order of the results will be starting from the point of interest to the user. This will apply to all other search categories such as lawyers, doctors, schools etc.

The present inventive system would convert the input provided by the user (or derive from information not provided directly by the user but is part of the message received) into a latitude/longitude pair. The search results would be provided starting from entities whose latitude/longitude is closest to that of the user's and progressively provide information that is increasingly farther away from the starting (or focal) point. The desired results could also be provided based on “well known” locations such as Airports or other landmarks.

Current search engines are useful for searching information on the Web. However, it is not easy to locate regional businesses. This invention would make locating regional businesses easy, using zip codes and commonly known names. For e.g. users can locate gas stations using the following “http://600090.gasstations.in” or http://20191.800gasstations.us or http://adyar.800gasstations.in”. The same search could be entered in a free-format text form like conventional search engines (for e.g. users can enter “gas stations 20191” in the text box and hit “enter” on the keyboard). The search results would start from the zip code 20191, provide information about all gas stations within the zip code 20191 but in the order starting from the point of interest. It would provide information on gas stations in the neighboring zip codes. It is possible that gas stations in other zip codes are closer than some within this zip code. The closer ones in other zip codes will be provided ahead of the one's within this zip code but farther away from the point of interest. The zip code “20191” becomes the focal point of the result for this search. The results are given within a certain radius of the zip code “20191” (the length of the arc, in miles/kilometers, is based on the entity searched). The results are displayed in an ascending order of the entities distance to the center of zip code “20191” (starting from the closest location from the one that the user desires). The search can also be performed in a free format text as in existing search engine. The format “http://20191.800gasstations.us” shown is for illustration purpose only and does not limit the other ways in which the same search can be performed.

The reason for such a search engine is that most people conduct commerce near one's place of residence and current search engine does not cater to this need.

Identifying the Starting Point for the Search Results: The search can be performed in several ways. The user can provide the category i.e. doctors, lawyers, schools etc. along with regional information in any of the following forms.

1.By providing the Zip Code.

2.By telephone area Code. The entire telephone number could be used to get the users address. However, in some countries the data for mapping of telephone number to a street address is not available and prohibited due to security reasons. The area code and telephone prefix is sufficient to derive the zip code.

3. Well-known names such as Landmarks, airport name, airport code etc.

4. Street Name such as Wilshire Boulevard etc.

The search engine can also “learn or derive” the country of residence by the following means. If the country cannot be derived the user may be asked to enter that information. If the incorrect country/region is assumed (this might happen if the user has a static IP address and moves to another geographical location where it can still be used), the user can override that information with the new country/location information.

1. From the IP (Internet protocol) address. The IP address (both Version 4 and IP version 6) are assigned directly or indirectly through International Assigned Number Authority (IANA), Internet Service providers (ISP's) or other related agencies. Since these are assigned in an orderly manner the country to which the IP address is allocated or reserved can be derived or learnt.

2. The structure of the Zip Code. For example, in the United States Zip codes are 5 digits and in India they are six digits long. The European countries have rules for Zip codes too.

3. The time of the search.

4. Explicitly provided by the User.

5. The ISP through which the search query is originating.

6. The Top Level Domain from which the search originated. For example www.111search.co.in (for India) or www.111search.us (for United States). The TLD (Top Level Domain) can also be used to infer the country. This will not be useful if the search originated from a ”.com” TLD.

7. From the telephone number for e.g. 540825xxxx (Where “xxxx” is the last 4 digits of the telephone number) in the US or 44-2491xxxx in Chennai India. In the example above “540” is the Virginia Area code and “825” indicates that it is Culpeper Virginia (Hence Zip code is 22701 derived from this combination). Similarly in the example for India (“44” is for the City Chennai and “2491” indicates it is “Adyar or Besant nagar” Area).

8. Combination of one or more of the above. Some of these rules for deducing the region may not be sufficient in itself. However, with the combination of one or more of the above rules, the region can be deduced with a high degree of accuracy. The user obviously will be provided the ability to explicitly provide the region or override what has been inferred.

Latitude/Longitude of the Zip Code.The latitude/longitude pairs of Zip codes are readily available. This will not be elaborated in this document. Moreover, given the latitude/longitude, one can also find all the latitudes/longitudes within a certain distance for e.g. one can find all latitudes/longitudes that are within 2 miles of a given latitude/longitude pair. The 2 miles is used as an example it can be substituted with other values. Once all the latitude/longitude's of all-relevant entities are determined (in relation to the focal point of the search), they will be sorted on their distance to the focal latitude/longitude and displayed in ascending order of distance (i.e. closest one to the focal point will be displayed first and so on).

For example if we want to search all card dealerships around Dulles airport, Virginia and if the latitude/longitude of Dulles airport is 34.893°N, 127.2°E. Let the boundaries of a 10 mile radius search be 37.843°N, 129.2°E, 35.843°N, 125.2°W, 32.843°S, 129.2°E and 32.893°S, 125.2°W. Then all entities that have latitude/longitude within this boundary will be display starting from the closest to 34.893°N, 127.2°E.

A mobile user will also be able to search for restaurants/gas stations etc. nearest to his/her current location.

The preferred embodiments of the present invention overcome the problems associated with emails, searching the Internet, and will provide more options to the consumers.

1. A method for accessing an internet site and sending email, comprising:
Sending an email request to another user using the telephone number of the recipient of the email;

2. The method according to claim 1, wherein email generated can be sent to a particular user of the telephone number.

3. The method according to claim 1, wherein the email generated based on the telephone number is forwarded to another email address used by the recipient.

4. The method according to claim 1, wherein users can customize mail boxes using the same telephone number.

5. The method as described in claim 1 further comprising:
sending emails from a wireless device by using just the telephone number of the recipient.

6. The method as described in claim 1 further comprising:
Conducting secure e-commerce using the telephone number of the buyer.

7. A method of providing search capability for users, in locating businesses or acquiring information on the web, pertaining to a given geographic location or Zip code.

8. The method as described in claim 7 further comprising:
receiving input from a display device; and receiving the request string through the input screen.

9. The method as described in claim 7 wherein the determining further includes: analyzing the input to determine the geographic location of interest; and providing search results in the order of relevance to the location.

10. An input information handling system comprising: one or more CPU's, memory, hard disk and a network interface; a generic tool to compute neighboring latitudes/longitudes within a certain distance (provided as a parameter to the tool); and the ability to display one or more results of the search.

11. The method as described in claim 7 further comprising:
Determining the latitude and longitude from the input string, which is a postal Zip Code.

12. The method as described in claim 7 further comprising:
Determining the latitude and longitude from the input string, which is telephone number.

13. The method as described in claim 7 further comprising:
Determining the latitude and longitude from the input string, which is a telephone area code.

14. The method as described in claim 7 further comprising:
Determining the latitude and longitude from the input string, which is an airport code.

15. The method as described in claim 7 further comprising:
Determining the latitude and longitude from the input string, which is a landmark or well-known mnemonic.

16. The method as described in claim 7 further comprising:
Determining the category of interest for the search from the input string such as doctors, lawyers, churches, schools etc.

17. The method as described in claim 7 further comprising:
Determining the latitude and longitude from the format of the input string, which could be one or more of the following length and structure of the Zip Code (5 Digits, 6 digits, alphanumeric etc), telephone area code, airport code, landmarks etc.,

18. The method as described in claim 7 further comprising:
Determining the latitude and longitude from the telephone number provided in the input, using the telephone area code and the prefix..

19. The method as described in claim 7 further comprising:
Using the latitude and longitude derived from a GPS system for getting location specific search results on a mobile device.

20. The method as described in claim 7 further comprising:
The search being requested using “well known” geographic keyword, such as city name, area name, landmark etc.

21. The method as described in claim 7 further comprising:
Deriving the country code of the desired search based on the structure of the Zip code.

22. The method as described in claim 7 further comprising:
Deriving the Zip Code for the search based on the telephone area code.

23. The method as described in claim 7 further comprising:
Deriving the region code based on the User's IP address.

24. The method as described in claim 7 further comprising:
Providing advertisements to mobile devices based on their current location.
